(19) United States
(12) Patent Application Publication
(10) Pub. No.: US 2023/0370479 A1
(43) Pub. Date: Nov. 16, 2023

(54) AUTOMATIC GENERATION OF ATTACK PATTERNS FOR THREAT DETECTION

(71) Applicant: FORESCOUT TECHNOLOGIES, INC., San Jose, CA (US)

(72) Inventors: Elisa Costante, Eindhoven (NL); Daniel Ricardo dos Santos, Rotterdam (NL); Cristoffer Leite da Silva, Eindhoven (NL)

(21) Appl. No.: 18/072,238

(22) Filed: Nov. 30, 2022

Related U.S. Application Data
(60) Provisional application No. 63/390,519, filed on Jul. 19, 2022.
(60) Provisional application No. 63/341,754, filed on May 13, 2022.

(51) Int. Cl. H04L 9/40

(52) U.S. Cl. CPC H04L 63/1416

(57) ABSTRACT

Systems and methods for automatic attack pattern generation from cyber threat intelligence are described. Attack pattern generation includes obtaining cyber threat intelligence including a set of methodologies used by a cyber threat and identifying a set of network detectable events associated with the set of methodologies used by the cyber threat. An attack pattern is generated including the plurality of detectable events associated with the plurality of methodologies.

### RELATED APPLICATIONS

This application claims priority from and the benefit of U.S. Provisional Patent Application No. 63/341,754 filed on May 13, 2022, and U.S. Provisional Patent Application No. 63/390,519 filed on Jul. 19, 2022, the entire contents of which are incorporated herein by reference in their entirety.

### TECHNICAL FIELD

Aspects and implementations of the present disclosure relate to network monitoring, and more specifically, automatic generation of attack patterns for threat detection.

### BACKGROUND

As technology advances, the number and variety of devices or entities that are connected to communications networks are rapidly increasing. Each device or entity may have its own respective vulnerabilities which may leave the network open to compromise or other risks. Preventing the spreading of an infection of a device or entity, or an attack through a network can be important for securing a communication network. Known methodologies such as attacker behaviors, steps taken by threat actors to achieve their goals, and indicators of those threat actors are collected in cyber threat intelligence that can be used by security analysts to identify and mitigate threats to a network.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative communication network in accordance with one implementation of the present disclosure.

FIG. 2 depicts an example system for automatically generating attack patterns from cyber threat intelligence, in accordance with one implementation of the present disclosure.

FIG. 3A depicts an example categorization of cyber threat intelligence levels, in accordance with some embodiments of the present disclosure.

FIG. 3B depicts an example selection of tactics, techniques, and procedures (TTPs) of threat actors from known TTPs based on cyber threat intelligence, in accordance with embodiments of the present disclosure.

FIG. 4 depicts an example dictionary of network detectable events mapped to known tactics, techniques, and procedures, in accordance with one implementation of the present disclosure.

FIG. 5 depicts an example set of network detectable events identified as an attack pattern based on cyber threat intelligence, in accordance with one implementation of the present disclosure.

FIG. 6 depicts an example attack pattern generated from mapped event types, in accordance with one implementation of the present disclosure.

FIG. 7 depicts a flow diagram of an example process for automatic generation of an attack pattern from cyber threat intelligence, according to embodiments of the present disclosure.

FIG. 8 depicts a flow diagram of another example process for automatic generation of an attack pattern from cyber threat intelligence, according to embodiments of the present disclosure.

FIG. 9 depicts a component diagram for automatic generation of attack patterns based on cyber threat intelligence, according to embodiments of the present disclosure.

FIG. 10 is a block diagram illustrating an example computer system, in accordance with one implementation of the present disclosure.

### DETAILED DESCRIPTION

Aspects and implementations of the present disclosure are directed to automatic (e.g., without user or human interaction) generation of attack patterns for threat detection. The systems and methods disclosed can be employed with respect to network security, among other fields. More particularly, it can be appreciated that devices or entities with vulnerabilities are a significant and growing problem. At the same time, the proliferation of network-connected devices (e.g., internet of things (IoT) devices such as televisions, security cameras (IP cameras), wearable devices, medical devices, etc.) and the continuous addition and adaptation of cyber security threats can make it difficult to effectively ensure that network security is maintained.

Cyber threat intelligence (CTI) includes analyzed information about capabilities, infrastructure, methods, and victims of cyber threat actors. Such intelligence helps organizations to better perform threat detection, incident response, threat hunting, and risk management, as well as to make strategic decisions to protect their network, information, and infrastructure.

CTI can be divided into several levels of specificity including strategic, tactical, and operational levels of information. Conventionally, only the lowest level information, operational information, can be used by threat detection systems to automatically detect cyber threats. The operational information may be in the form of Indicators of Compromise (IoCs), such as file hashes or known malicious IP addresses and domain names, or other specific threat details. These IoCs can be matched with network traffic or endpoint information in real-time to generate alerts that indicate a network intrusion is taking place. For example, network traffic may be monitored or inspected in real-time to identify and match information from the network traffic to the IoCs.

Tactical intelligence describes the higher-level information such as behavior and methodologies (e.g., tactics, techniques, and procedures (TTPs)) used by cyber threat actors. Using the methodologies and behaviors described by the TTPs can be beneficial because TTPs are more difficult for an attacker to change than IoCs. For example, changing an IoC may involve simply acquiring new infrastructure or recompiling a malware with slightly different code to modify the IoC fingerprint of the attacker while TTPs are the required methodologies and steps that the attacker must take to compromise a system. Conventional systems are unable to automatically ingest tactical intelligence into threat detection systems. Accordingly, tactical intelligence is conventionally only used by human analysts to perform manual threat investigation. Although several embodiments provided herein are described with respect to TTPs, it should be noted any form of tactical intelligence may be used when referring to TTPs.

Embodiments of the present disclosure include an attack pattern generator to extract TTPs from public CTI databases and automatically (e.g., without user or human interaction) map the tactical information of the CTI into attack patterns that can be used by a threat detection system to group individual alerts or events into threat incidents (e.g., a series or group of events corresponding to a threat incident). In some embodiments, the attack pattern generator may map or correlate high-level tactical information (e.g., TTPs) to network detectable event types (e.g., event types of a network intrusion detection system). Accordingly, the attack pattern generator may automatically (e.g., without user or human interaction) ingest tactical information of CTI reports to produce attack patterns including network detectable events. Thus, the attack pattern generator may provide for network intrusion automation beyond the use of lower-level indicators of compromise used by conventional systems.

In some embodiments, a security analyst may provide one or more hashes or other identifiers of a cyber threat to search one or more sources of CTI and to identify and retrieve CTI reports related to the cyber threat. The attack pattern generator may parse the retrieved CTI to identify and extract tactical information including behaviors and methodologies, such as TTPs, included in the CTI. In some examples, the attack pattern generator may filter the CTI reports for quality and relevance to attack pattern generation for the cyber threat. In some embodiments, the attack pattern generator identifies network detectable events that correspond to the tactical information extracted from the CTI. For example, the attack pattern generator may match specific methodologies or behaviors (e.g., TTPs) to network detectable events or event types (e.g., via a TTP to event type dictionary). The attack pattern generator may then generate the attack pattern to include the network detectable events or event types that are mapped to the methodologies or behaviors. It should be noted that in some examples, not every methodology or behavior has a corresponding network detectable event. Accordingly, the attack pattern generator may generate the attack pattern using only the network detectable events or event types that are identified to correspond to one of the methodologies or behaviors.

Once the attack pattern is generated, a network monitoring device may monitor traffic of a network for occurrences of the attack pattern. In some examples, the network monitoring device may identify an occurrence of the attack pattern upon detecting each of the network detectable events. In some examples, the attack pattern occurrence is detected if the network detectable events are detected within a particular time span and in a sequential order. In some embodiments, the network monitoring device may determine if a threshold number or percentage of the network detectable events of the attack pattern have occurred (e.g., within a window of time). The network monitoring device may then provide an alert identifying the potential cyber threat actor based on the triggered attack pattern. It should be noted that although the present disclosure is described with respect to network detectable events, embodiments are also applicable to use of events that occur and are detectable at a host device, or entity, such as file read, write, process creation, etc., or anywhere else within a network.

Embodiments of the present disclosure provide for the use of higher-level cyber threat intelligence in an automated and actionable manner. Accordingly, embodiments may greatly reduce the effort of creating and maintaining attack patterns for threat detection and attack attribution, especially as new threat actors are detected or when known threat actors change their methodologies (e.g., TTPs). With an increasing set of attack patterns, embodiments may reduce alert fatigue of security analysts from manual review and investigation of tactical information. Additionally, embodiments provide attribution and identification of threat actors for detected incidents. Furthermore, embodiments provide for the enrichment of public cyber threat intelligence with new facts as they are detected in networks of different entities.

It can be appreciated that the described technologies are directed to and address specific technical challenges and longstanding deficiencies in multiple technical areas, including but not limited to network security, monitoring, and policy enforcement. It can be further appreciated that the described technologies provide specific, technical solutions to the referenced technical challenges and unmet needs in the referenced technical fields.

Although embodiments are described herein with reference to network devices, embodiments also apply to any entity communicatively coupled to the network. An entity or entities, as discussed herein, include devices (e.g., computer systems, for instance laptops, desktops, servers, mobile devices, IoT devices, operational technology (OT) devices, etc.), endpoints, virtual machines, services, serverless services (e.g., cloud-based services), containers (e.g., user-space instances that work with an operating system featuring a kernel that allows the existence of multiple isolated user-space instances), cloud-based storage, accounts, and users. Depending on the entity, an entity may have an IP address (e.g., a device) or may be without an IP address (e.g., a serverless service).

Enforcement points may be one or more network entities (e.g., firewalls, routers, switches, virtual switch, hypervisor, software-defined network (SDN) controller, virtual firewall, etc.) that are able to enforce access or other rules, access control lists (ACLs), or the like to control (e.g., allow or deny) communication and network traffic (e.g., including dropping packets) between the entity and one or more other entities communicatively coupled to a network. Access rules may control whether an entity can communicate with other entities in a variety of ways including, but not limited to, blocking communications (e.g., dropping packets sent to one or more particular entities), allowing communication between particular entities (e.g., a desktop and a printer), allowing communication on particular ports, etc. It is appreciated that an enforcement point may be any entity that is capable of filtering, controlling, restricting, or the like communication or access on a network.

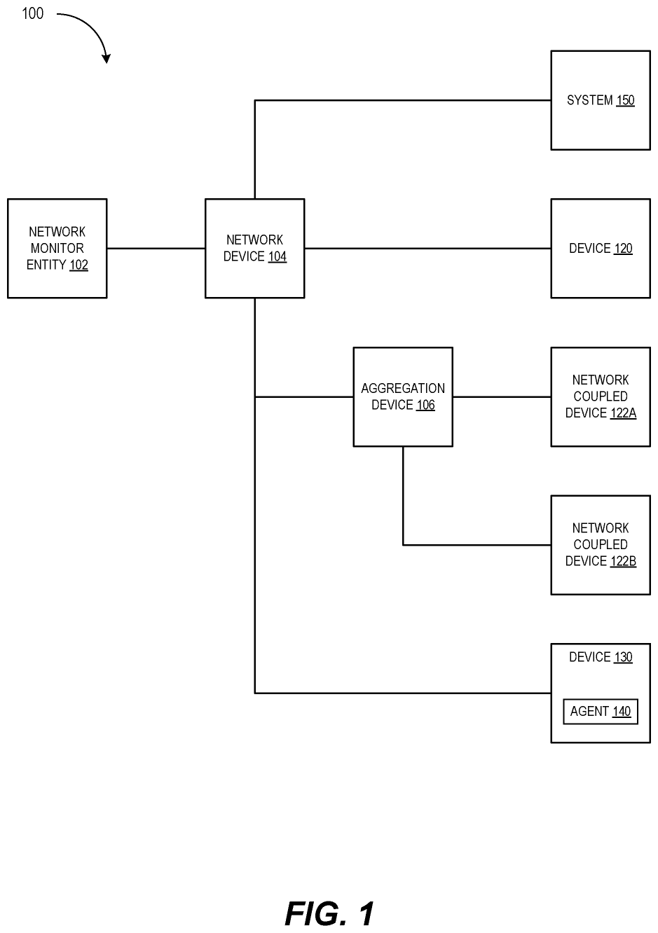

FIG. 1 depicts an illustrative communication network 100, in accordance with one implementation of the present disclosure. The communication network 100 includes a network monitor entity 102, a network device 104, an aggregation device 106, a system 150, devices 120 and 130, and network coupled devices 122A-B. The devices 120 and 130 and network coupled devices 122A-B may be any of a variety of devices including, but not limited to, computing systems, laptops, smartphones, servers, Internet of Things (IoT) or smart devices, supervisory control and data acquisition (SCADA) devices, operational technology (OT) devices, campus devices, data center devices, edge devices, etc. It is noted that the devices/entities of communication network 100 may communicate in a variety of ways including wired and wireless connections and may use one or more of a variety of protocols.

Network device 104 may be one or more network entities configured to facilitate communication among aggregation device 106, system 150, network monitor entity 102, devices 120 and 130, and network coupled devices 122A-B. Network device 104 may be one or more network switches, access points, routers, firewalls, hubs, etc.

Network monitor entity 102 may be operable for a variety of tasks, as described herein. Network monitor entity 102 may be a computing system, network device (e.g., router, firewall, an access point), network access control (NAC) device, intrusion prevention system (IPS), intrusion detection system (IDS), deception device, cloud-based device, virtual machine-based system, etc. Network monitor entity 102 may be communicatively coupled to the network device 104 in such a way as to receive network traffic flowing through the network device 104 (e.g., port mirroring, sniffing, acting as a proxy, passive monitoring, etc.). In some embodiments, network monitor entity 102 may include one or more of the aforementioned devices. In various embodiments, network monitor entity 102 may further support high availability and disaster recovery (e.g., via one or more redundant devices).

In some embodiments, the network monitor entity 102 may include an attack pattern generator to automatically (e.g., without user or human interaction) generate attack patterns from cyber threat information. In some examples, the attack pattern generator may be included on one or more devices of the network (e.g., network monitor entity 102, device 120 or 230, etc.), on a cloud computing system, or other system coupled to the network 100. The attack pattern generator may obtain CTI from one or more public or private sources and parse the CTI to identify behaviors or methodologies of a threat actor described by the CTI (e.g., TTPs). In some examples, the attack pattern generator maps the behaviors or methodologies to network detectable events that correspond to the behaviors or methodologies. The attack pattern generator then generates an attack pattern that includes the network detectable events. The attack pattern may include the events in a particular order corresponding to the behaviors or methodologies (e.g., TTPs) and may include a time window in which the events are to occur to trigger the attack pattern. The network monitor entity 102 may then monitor traffic of the network 100 for occurrence of the attack pattern. For example, the network monitory entity 102 may monitor the traffic for the occurrence of all or a subset of the network detectable events of the attack pattern within the particular window of time (e.g., an estimated time over which a threat actor may perform the methodologies from the CTI). The network monitor entity 102 may then provide an alert and identification of potential threat actors in response to the occurrence and detection of the attack pattern.

In some embodiments, network monitor entity 102 may monitor a variety of protocols (e.g., Samba, hypertext transfer protocol (HTTP), secure shell (SSH), file transfer protocol (FTP), transfer control protocol/internet protocol (TCP/IP), user datagram protocol (UDP), Telnet, HTTP over secure sockets layer/transport layer security (SSL/TLS), server message block (SMB), point-to-point protocol (PPP), remote desktop protocol (RDP), windows management instrumentation (WMI), windows remote management (WinRM), etc.).

The monitoring of entities by network monitor entity 102 may be based on a combination of one or more pieces of information including traffic analysis, information from external or remote systems (e.g., system 150), communication (e.g., querying) with an aggregation device (e.g., aggregation device 106), and querying the device itself (e.g., via an API, CLI, web interface, SNMP, etc.), which are described further herein. Network monitor entity 102 may be operable to use one or more APIs to communicate with aggregation device 106, device 120, device 130, or system 150. Network monitor entity 102 may monitor for or scan for entities that are communicatively coupled to a network via a NAT device (e.g., firewall, router, etc.) dynamically, periodically, or a combination thereof.

Device 130 can include agent 140. The agent 140 may be a hardware component, software component, or some combination thereof configured to gather information associated with device 130 and send that information to network monitor entity 102. The information can include the operating system, version, patch level, firmware version, serial number, vendor (e.g., manufacturer), model, asset tag, software executing on an entity (e.g., anti-virus software, malware detection software, office applications, web browser(s), communication applications, etc.), services that are active or configured on the entity, ports that are open or that the entity is configured to communicate with (e.g., associated with services running on the entity), media access control (MAC) address, processor utilization, unique identifiers, computer name, account access activity, etc. The agent 140 may be configured to provide different levels and pieces of information based on device 130 and the information available to agent 140 from device 130. Agent 140 may be able to store logs of information associated with device 130. Network monitor device 102 may utilize agent information from the agent 140. While network monitor entity 102 may be able to receive information from agent 140, installation or execution of agent 140 on many entities may not be possible, e.g., IoT or smart devices.

System 150 may be one or more external, remote, or third-party systems (e.g., separate) from network monitor entity 102 and may have information about devices 120 and 130 and network coupled devices 122A-B. System 150 may include a vulnerability assessment (VA) system, a threat detection (TD) system, endpoint management system, a mobile device management (MDM) system, a firewall (FW) system, a switch system, an access point system, etc. Network monitor entity 102 may be configured to communicate with system 150 to obtain information about devices 120 and 130 and network coupled devices 122A-B on a periodic basis, as described herein. For example, system 150 may be a vulnerability assessment system configured to determine if device 120 has a computer virus or other indicator of compromise (IOC).

The vulnerability assessment (VA) system may be configured to identify, quantify, and prioritize (e.g., rank) the vulnerabilities of an entity. The VA system may be able to catalog assets and capabilities or resources of an entity, assign a quantifiable value (or at least rank order) and importance to the resources, and identify the vulnerabilities or potential threats of each resource. The VA system may provide the aforementioned information for use by network monitor entity 102.

The advanced threat detection (ATD) or threat detection (TD) system may be configured to examine communications that other security controls have allowed to pass. The ATD system may provide information about an entity including, but not limited to, source reputation, executable analysis, and threat-level protocols analysis. The ATD system may thus report if a suspicious file has been downloaded to an entity being monitored by network monitor entity 102.

Endpoint management systems can include anti-virus systems (e.g., servers, cloud-based systems, etc.), next-generation antivirus (NGAV) systems, endpoint detection and response (EDR) software or systems (e.g., software that record endpoint-system-level behaviors and events), compliance monitoring software (e.g., checking frequently for compliance).

The mobile device management (MDM) system may be configured for administration of mobile devices, e.g., smartphones, tablet computers, laptops, and desktop computers. The MDM system may provide information about mobile devices managed by MDM system including operating system, applications (e.g., running, present, or both), data, and configuration settings of the mobile devices and activity monitoring. The MDM system may be used get detailed mobile device information which can then be used for device monitoring (e.g., including device communications) by network monitor entity 102.

The firewall (FW) system may be configured to monitor and control incoming and outgoing network traffic (e.g., based on security rules). The FW system may provide information about an entity being monitored including attempts to violate security rules (e.g., unpermitted account access across segments) and network traffic of the entity being monitored.

The switch or access point (AP) system may be any of a variety of network entities (e.g., network device 104 or aggregation device 106) including a network switch or an access point, e.g., a wireless access point, or combination thereof that is configured to provide an entity access to a network. For example, the switch or AP system may provide MAC address information, address resolution protocol (ARP) table information, device naming information, traffic data, etc., to network monitor entity 102 which may be used to monitor entities and control network access of one or more entities. The switch or AP system may have one or more interfaces for communicating with IoT or smart devices or other entities (e.g., ZigBee™, Bluetooth™, etc.), as described herein. The VA system, ATD system, and FW system may thus be accessed to get vulnerabilities, threats, and user information of an entity being monitored in real-time which can then be used to determine a risk level of the entity.

Aggregation device 106 may be configured to communicate with network coupled devices 122A-B and provide network access to network coupled devices 122A-B. Aggregation device 106 may further be configured to provide information (e.g., operating system, device software information, device software versions, device names, application present, running, or both, vulnerabilities, patch level, etc.) to network monitor entity 102 about the network coupled devices 122A-B. Aggregation device 106 may be a wireless access point that is configured to communicate with a wide variety of entities through multiple technology standards or protocols including, but not limited to, Bluetooth™, Wi-Fi™, ZigBee™, Radio-frequency identification (RFID), Light Fidelity (Li-Fi), Z-Wave, Thread, Long Term Evolution (LTE), Wi-Fi™ HaLow, HomePlug, Multimedia over Coax Alliance (MoCA), and Ethernet. For example, aggregation device 106 may be coupled to the network device 104 via an Ethernet connection and coupled to network coupled devices 122A-B via a wireless connection. Aggregation device 106 may be configured to communicate with network coupled devices 122A-B using a standard protocol with proprietary extensions or modifications.

Aggregation device 106 may further provide log information of activity and attributes of network coupled devices 122A-B to network monitor entity 102. It is appreciated that log information may be particularly reliable for stable network environments (e.g., where the types of entities on the network do not change often). The log information may include information of updates of software of network coupled devices 122A-B. The network monitor entity 102 may use the information collected from each system or device described above to identify events that included in the automatically generated attack pattern to identify occurrence of the attack pattern (e.g., an ongoing attack), as described herein.

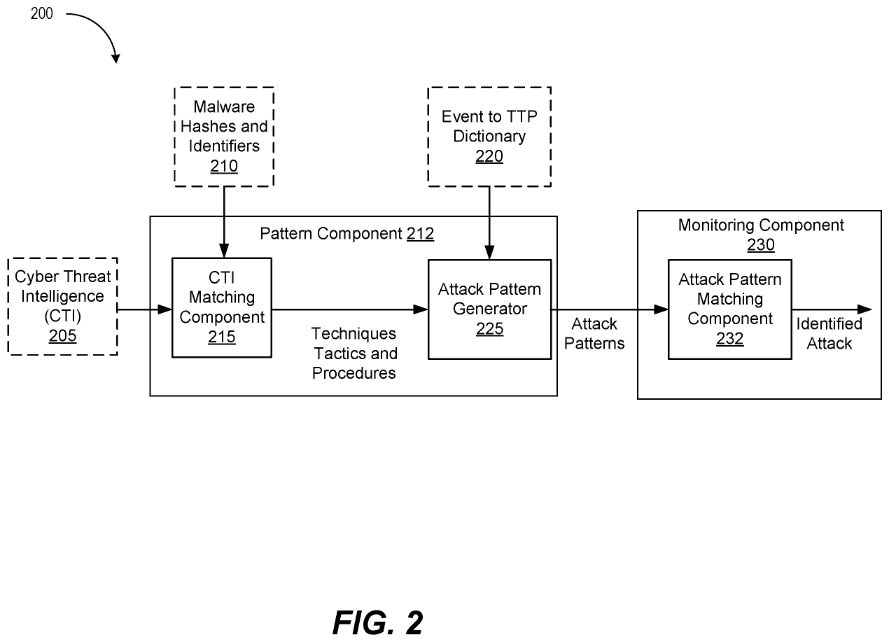

FIG. 2 illustrates an example of a system 200 for automatically generating attack patterns from cyber threat intelligence. The system includes a pattern component 212 including CTI matching component 215 and attack pattern generator 225. The system further includes monitoring component 230 which includes attack pattern matching component 232. In some examples, the pattern component 212 and monitoring component 230 may be included together at the network monitor device (e.g., network monitor device 102). In other embodiments, the pattern component 212 may execute on a separate system from the monitoring component 230. For example, the pattern component 212 may execute on a separate device, on a cloud computing system, etc., to generate attack patterns. The pattern component 212 may then provide the attack patterns to the monitoring component 230 for local network monitoring.

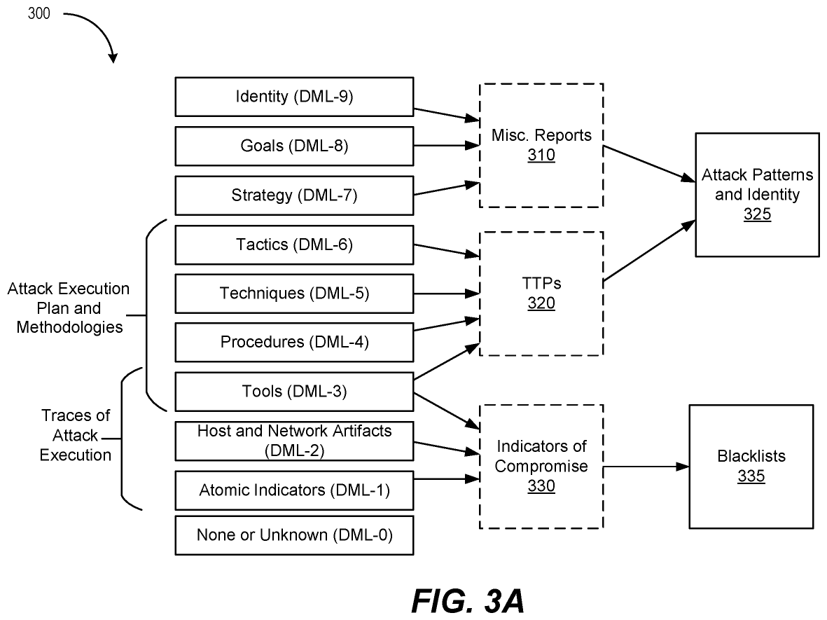

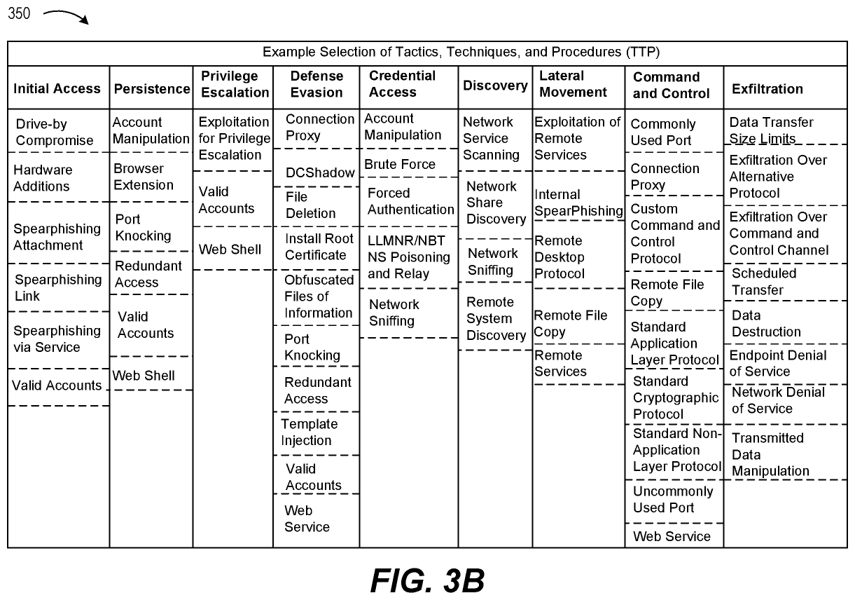

In some embodiments, a security analyst or other source may provide malware hashes and identifiers 210 to the CTI matching component 215 of the pattern component 212. In some examples, the malware hashes and identifiers 210 may be accessed from one or more sources (e.g., indicated by a security analyst) providing information about a cyber threat. The CTI matching component 215 then retrieves corresponding cyber threat intelligence (CTI) based on the malware hashes and identifiers 210 (e.g., from public or private sources, databases, etc.). The CTI 205 may be collections of information and analysis about one or more cyber threat actors, groups, etc. For example, as illustrated by FIG. 3A, the CTI 205 may include several levels of information including specific low-level indicators of compromise up to higher-level information such as goals, strategy, tactics, techniques, and procedures that have been identified, aggregated, and analyzed from one or more sources (e.g., collected from previous attacks by the threat actors).

In some embodiments, the CTI matching component 215 may parse the CTI that has been retrieved and identify the higher-level tactical information of the CTI (e.g., TTPs). The CTI matching component 215 may further filter the retrieved CTIs and score them based on the number and relevance of the TTPs identified from the CTI. For example, the CTI matching component 215 may determine if each CTI 205 includes a sufficient quality of information to be used for attack pattern generation. Based on the quality of information, the CTI matching component 215 may filter out CTIs with less than a threshold quality (e.g., based on amount of information, specificity of information, context, structure, and organization of information). For example, the CTI matching component 215 may filter out CTI reports that include only low-level information, such as IoCs. The CTI matching component 215 may then determine the number, relevance, quality, or any combination thereof, of the TTPs identified from the CTI 205 and rank the CTIs for pattern generation in order from most TTPs and highest quality to fewest TTPs and lowest quality.

The attack pattern generator 225 receives the TTPs from the CTI matching component and compares the TTPs to an event to TTP dictionary 220. The event to TTP dictionary 220 may include a mapping or correlation between specific TTPs and detectable events or event types. The detectable events may include events detectable on the network via network traffic monitoring, at host devices of the network, or elsewhere within the network that detectable events occur. In some embodiments, the TTP dictionary 220 may also include mapping between TTPs and host detectable events (e.g., events occurring and detectable at a host device). Accordingly, the attack pattern generator 225 can identify the TTPs received from the CTI matching component 215 that are included in the event to TTP dictionary 220 and that are correlated with a host or network detectable event that can be used for threat detection. The attack pattern generator 225 may generate an attack pattern that includes the detectable events corresponding to the TTPs from the CTI 205. Thus, the attack pattern generator 225 creates the attack pattern from the TTPs that can be detected on the network (e.g., via a network detectable events), at a host device, via network traffic, etc. The attack pattern may include each network detectable event or event type corresponding to the TTPs of the CTIs in a particular order. In some examples, the attack pattern may include a time window, an order of occurrence of the network detectable events (e.g., based on the order that the TTPs would be performed as indicated from the CTIs) and a threat level associated with the attack pattern.

In some embodiments, the attack pattern matching component 232 of the monitoring component 230 may then receive the automatically generated attack patterns and compare network traffic and detected events (e.g., incidents detected by a network intrusion detection system) from the network traffic to the attack patterns. Thus, the attack pattern matching component 232 may identify when a series of detected events on the network indicate the occurrence of a potential threat incident based on the detected events matching the generated attack pattern. In some examples, the monitoring component 230 may also receive and use indicators of compromise, as described above, to further identify potential cyber threats to a network in addition to the use of attack patterns.

FIG. 3A illustrates an example categorization of cyber threat intelligence levels, in accordance with embodiments of the present disclosure. As depicted, CTI 300 can include several levels of information (e.g., represented by a detection maturity level (DML)). Conventionally, traces of attack execution such as tools, host and network artifacts, and atomic indicators can be collected as indicators of compromise 330. Indicators of compromise 330 may include low-level fingerprint type information of attacker devices, hardware, and tools, such as MAC or IP addresses or the like. Indicators of compromise 330 may allow intrusion detection systems to generate blacklists 335 that prevent or block access of the network by threat actors with signatures or fingerprints corresponding to the indicators of compromise 330.

The CTI may further include tactical information such as attack execution plan and methods of cyber threat actors. The tactical information may include tactics, techniques, procedures, and tools used by the threat actor. Such information may be extracted as TTPs 320 to be used to generate attack patterns 325 to detect threats on a network. Additionally, the CTI may include information identifying the threat actor or group along with the goals and strategies that the threat actor entails. For example, the general intentions and strategies used by a particular threat actor (e.g., ransomware of a certain type used in a particular manner) may be known and included in the CTI.

FIG. 3B depicts a diagram 350 illustrating example tactics, techniques, and procedures that may be included in a CTI. In some examples, the example selection of TTPs are the methodologies that are detectable within a network. A cyber threat actor may use a combination of the different categories of TTPs in their attack (e.g., as a playbook for an attack). Accordingly, by identifying the TTPs that a cyber actor uses (e.g., via the CTI), an attack pattern can be generated for the TTPs of the CTI that can be detected on the network (e.g., via a network detectable event). It should be noted that the depicted TTPs are illustrative and that any other known or unknown TTPs may be extracted and mapped to network events.

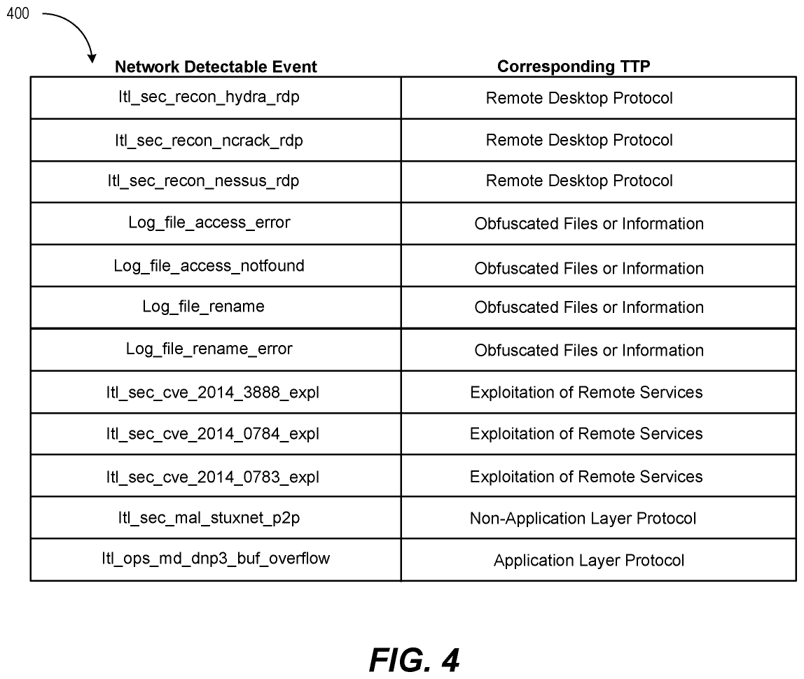

FIG. 4 depicts an example dictionary of network detectable events corresponding to known tactics, techniques, and procedures. The dictionary may include a mapping between TTPs and network detectable events or event types. For example, as depicted in FIG. 4, a network detectable event identified by an intrusion detection system may include an identifier of “itl_sec_recon_hydra_rdp”, “itl_sec_recon_ncrack_rdp”, or “itl_sec_recon_nessus_rdp” which are mapped to a TTP type of “Remote Desktop Protocol.” Additional examples include detectable events “log_file_access_error”, “log_file_access_notfound”, “log_file_rename”, and “log_file_rename error” corresponding to “Obfuscated Files or Information.” Additional events “itl_sec_cve_2014_3888_expl”, “itl_sec_cve_2014_0784_expl”, and “itl_sec_cve_2014_0783_expl” may correspond to “Exploitation of Remote Services.” Further examples include events itl_sec_mal_stuxnet_p2p″ mapped to “Non-Application Layer Protocol” and “itl_ops_md_dnp3_buf_overflow” mapped to “Application Layer Protocol.” The depicted examples are intended to be illustrative and not limiting. The dictionary may include any type or number of detectable network events and any number or type of TTPs that correspond to each of the events. An attack pattern generator may use the dictionary to identify the TTPs extracted from a CTI that are mapped to a detectable event and generate an attack pattern of the corresponding events mapped to the TTPs.

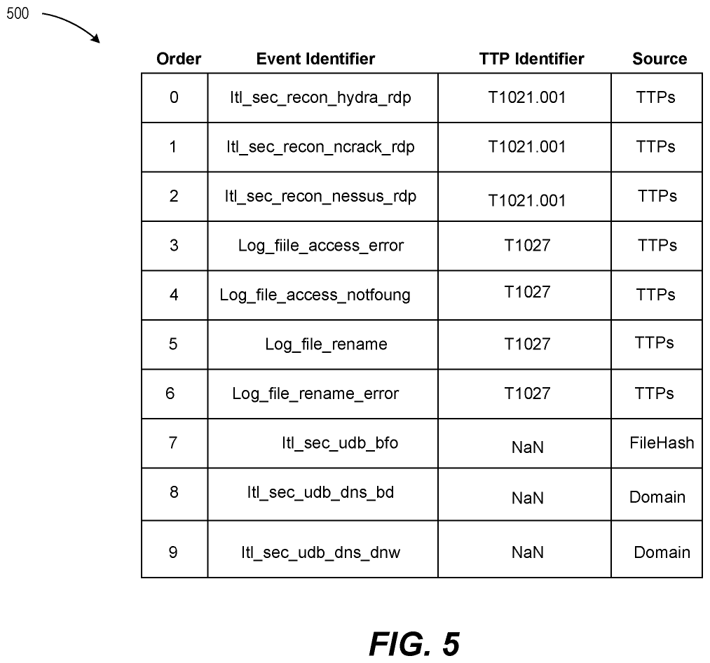

FIG. 5 depicts an example set of network detectable events identified as an attack pattern based on cyber threat intelligence. As described above with respect to FIG. 2, the TTPs may first be filtered to contain only those that can be detected by network activities, as opposed to endpoint-related TTPs. These TTPs are mapped to event types using a dictionary partially depicted in FIG. 4.

A list of event types is generated from this mapping, as shown in FIG. 5 (which also includes the last three event types coming not from TTPs per se but from the fact that there are file hashes and domain IoCs associated with this threat actor). In the example depicted list of events and TTPs of FIG. 5, there are two network-detectable TTPs: T1027 (Obfuscated Files or Information), T1021.001 (Remote Desktop Protocol), each of which correspond to one or more network detectable events. The TTP identifiers may correspond to an identifier in a TTP framework, such as MITRE ATT&CK (e.g., the framework depicted in FIG. 3B).

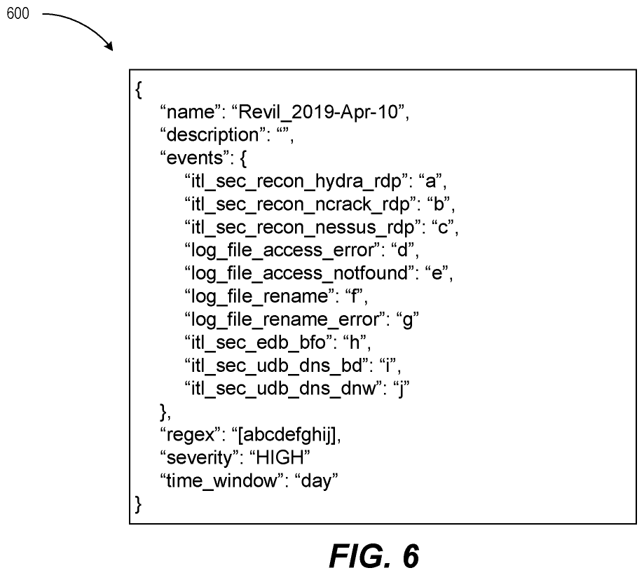

FIG. 6 depicts an example attack pattern generated from extracted event types, in accordance with one implementation of the present disclosure. The attack pattern generated from the event types may be generated in a javascript object notation (JSON) format. Each event type is mapped to a letter (“a” though “j”) which may be put together in a sequence in the form of a regular expression (“[abcdefghij]”). The pattern may also include a name, a description of the attack pattern, and a severity of the threat posed by the attacker.

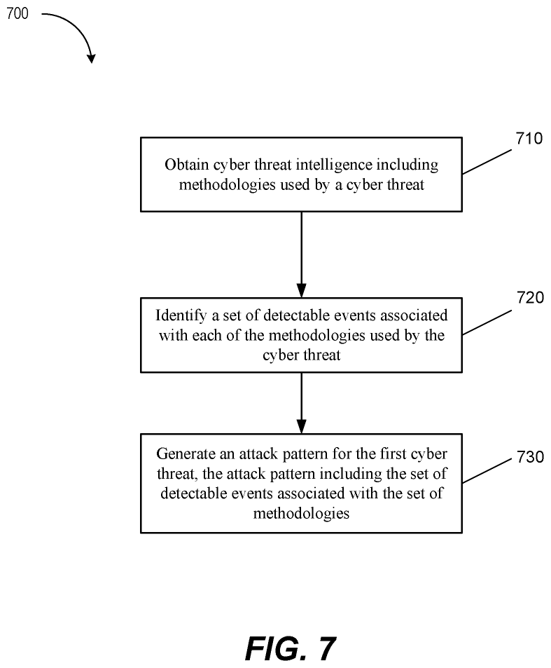

FIG. 7 depicts a flow diagram of aspects of process 700 for automatic generation of attack patterns for threat detection in accordance with one implementation of the present disclosure. Various portions of process 700 may be performed by different components (e.g., components of system 900) of an entity or device (e.g., network monitor entity 102).

Process 700 begins at block 710, where processing logic (e.g., network monitor entity 102) obtains cyber threat intelligence including methodologies used by a cyber threat. Cyber threat intelligence may include analyzed information about capabilities, infrastructure, methods, and victims of cyber threat actors. Cyber threat intelligence can be divided into several levels of specificity and utility including strategic, tactical, and operational levels of information. Operational information may include IoCs, such as file hashes or known malicious IP addresses and domain names, or other specific device or actor details. Tactical intelligence may include higher-level information such as behavior and methodologies (e.g., TTPs) of cyber threat actors.

At block 720, the processing logic (e.g., network monitor entity 102) identifies a set of detectable events associated with each of the methodologies used by the first cyber threat. In some examples, the processing logic determines a subset of the plurality of methodologies that are detectable within a network or at a host device on the network and generates the attack pattern to include the detectable events associated with the subset of the plurality of methodologies. For example, the processing logic may select each of the methodologies (e.g., TTPs) associated with or mapped to an event detectable on the network and filter out the methodologies that are not detectable on the network.

At block 730, the processing logic generates an attack pattern for the first cyber threat, the attack pattern including the set of detectable events associated with the set of methodologies. In some embodiments, after generation of the attack pattern the processing logic monitors network traffic to identify occurrences of incidents or network events that correspond the detectable events of the attack pattern. The processing logic may then identify if each of the detectable events of the attack have occurred within a particular window of time. In response to detecting the occurrence of each of the events of the attack pattern, the processing logic may generate and provide an indication or alert of a potential network threat. The processing logic may identify the cyber threat from the occurrence of the attack pattern (e.g., the attack pattern may include an identifier of the cyber threat for which it is generated). In some embodiments, the attack pattern may include a sequential order in which the detectable events must occur in order to the attack pattern to be triggered. In some examples, the attack pattern may be triggered and an alert provided upon detection of an occurrence of a threshold number of the detectable events of the attack pattern within a maximum period of time.

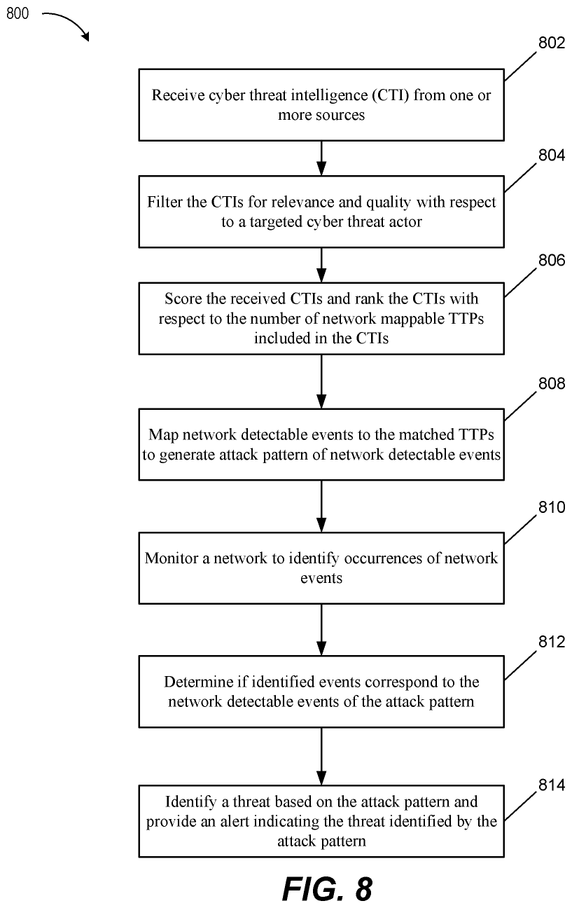

FIG. 8 depicts a flow diagram of aspects of process 800 for automatic generation of attack patterns for threat detection in accordance with one implementation of the present disclosure. Various portions of process 800 may be performed by different components (e.g., components of system 900) of an entity or device (e.g., network monitor entity 102).

Process 800 begins at block 802, where processing logic (e.g., network monitor entity 102) receives or otherwise obtains cyber threat intelligence from one or more sources. In some examples, a security analysis may provide hashes of a potential threat or cyber threat. The processing may then identify CTI that corresponds to the provided hashes. For example, CTI sources may be searches for the corresponding hash of the threat to determine if any CTI includes information relevant to the threat.

At block 804, the processing logic (e.g., network monitor entity 102) filters the CTIs for relevance and quality with respect to a targeted cyber threat. For example, the processing logic may filter out CTI reports that have a quality (e.g., information specificity, amount, etc.) below a particular threshold. In some embodiments, the quality and relevance of the targeted cyber threat may be determined by the specificity level of the information included in the CTI report. For example, the processing logic may filter out CTI reports that include only low-level information (e.g., only IoCs or some other threshold level of information).

At block 806, the processing logic (e.g., network monitor entity 102) scores the received CTIs and ranks the CTIs with respect to the number of network mappable TTPs included in the CTIs. For example, the processing logic may determine the number of network mappable TTPs of a CTI for the cyber threat and rank each of the CTIs based on the determined number. The larger number of network mappable TTPs may correspond to a higher granularity of detection and thus may provide for generation of a more accurate attack pattern.

At block 808, the processing logic (e.g., network monitor entity 102) generates an attack pattern by mapping network detectable events to TTPs using a dictionary of network detectable events and corresponding TTPs. Each TTP may either be detectable within a network or not detectable. A TTP may be detectable by a particular network event or incident, such as an alert or incident identification by an intrusion detection system. A detectable network event may be identified by a fingerprint, signature, request, operation, etc., that occurs within the network. Thus, each TTP may be mapped to one or more corresponding network events or network event types in a data structure, such as a table, dictionary, database, or the like. In some embodiments, the processing logic may map each of the network mappable TTPs to a corresponding network event or event type to generate a list of network detectable events. The list of network detectable events may be ordered in a sequential manner to provide an attack pattern that can be used to identify an attack by the cyber threat associated with the attack pattern.

At block 810, the processing logic (e.g., network monitor entity 102) monitors a network to identify occurrences of the network detectable events. At block 812, the processing logic (e.g., network monitor entity 102) determines if detected events correspond to the network detectable events included in the attack pattern. In some embodiments, the processing logic triggers the attack pattern if each of the network detectable events have occurred on the network. In some embodiments, the processing logic triggers the attack pattern if each of the network detectable events have occurred within a certain window of time (e.g., a window of time corresponding to a maximum amount of time the attack may occur) such as hours, days, weeks, etc.) In some embodiments, the processing logic triggers the attack pattern if a threshold number of the network detectable events have occurred to identify an ongoing attack. The triggering of the attack pattern may also provide a level of certainty that an attack is occurring and a threat or severity level associated with the attack.

At block 814, the processing logic (e.g., network monitor entity 102) identifies an ongoing attack by a cyber threat based on the attack pattern and provides an alert indicating the threat identified by the attack pattern and a threat or severity level of the attack.

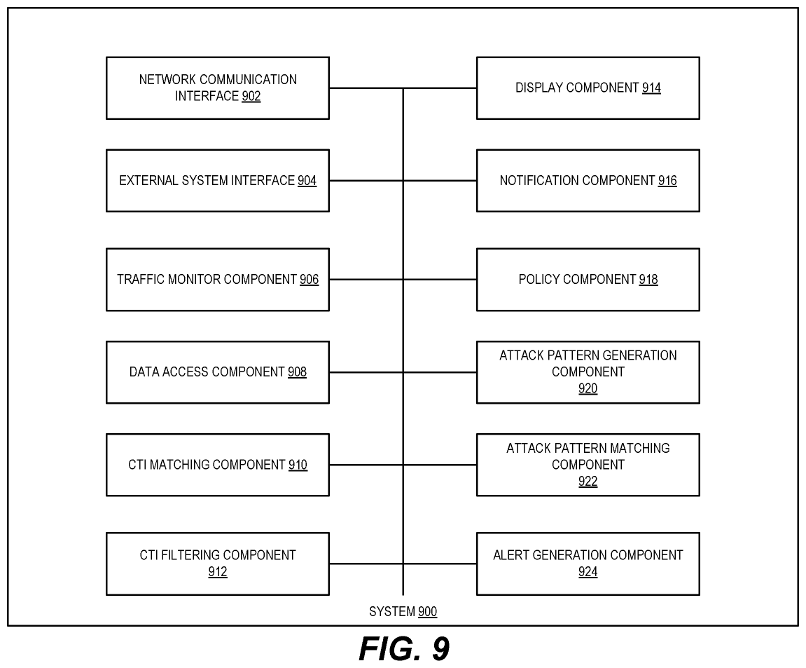

FIG. 9 depicts illustrative components of a system for automatic generation of attack patterns for threat detection, in accordance with one implementation of the present disclosure. Example system 900 or classifier 900 includes a network communication interface 902, an external system interface 904, a traffic monitor component 906, a data access component 908, a CTI matching component 910, a CTI filtering component 912, a display component 914, a notification component 916, a policy component 918, an attack pattern generation component 920, an attack pattern matching component 922, and an alert generation component 924. The components of system 900 may be part of a computing system or other electronic device (e.g., network monitor entity 102) or a virtual machine or device and be operable to monitor one or more entities communicatively coupled to a network, monitor network traffic, generate and match attack patterns from cyber threat intelligence, or perform one or more actions (e.g., security action, remediation action, etc.), as described herein. For example, the system 900 may further include a memory and a processing device, operatively coupled to the memory, which may perform the operations of or execute the components of system 900. The components of system 900 may access various data and characteristics or features associated with an entity (e.g., network communication information) and data associated with one or more entities. It is appreciated that the modular nature of system 900 may allow the components to be independent and allow flexibility to enable or disable individual components or to extend, upgrade, or combination thereof components without affecting other components thereby providing scalability and extensibility. System 900 may perform one or more blocks of flow diagrams 700-800. In some embodiments the components of 900 may be part of network monitor device (e.g., network monitor entities 102), in the cloud, or the various components may be distributed between local and cloud resources.

Communication interface 902 is operable to communicate with one or more entities (e.g., network device 104) coupled to a network that are coupled to system 900 and receive or access information about entities (e.g., device information, device communications, device characteristics, features, etc.), access information as part of a passive scan, send one or more requests as part of an active scan, receive active scan results or responses (e.g., responses to requests), as described herein. The communication interface 902 may be operable to work with one or more components to initiate access to sources of cyber threat intelligence characteristics for attack pattern generation, device characteristics, or determination of characteristics of an entity to allow determination of one or more features which may then be used for device compliance, asset management, standards compliance, classification, identification, risk assessment or analysis, vulnerability assessment or analysis, etc., as described herein. Communication interface 902 may be used to receive and store network traffic for monitoring for attack pattern occurrences, as described herein.

External system interface 904 is operable to communicate with one or more third party, remote, or external systems to access information including characteristics or features of an entity (e.g., to be used to determine a security aspects) or cyber threat intelligence. External system interface 904 may further store the accessed information in a data store. For example, external system interface 904 may access information from a vulnerability assessment (VA) system to enable determination of one or more compliance or risk characteristics associated with an entity, as well as identification of on-going cyber-attacks using attack patterns generated from CTI. External system interface 904 may be operable to communicate with a vulnerability assessment (VA) system, an advanced threat detection (ATD) system, a mobile device management (MDM) system, a firewall (FW) system, a switch system, an access point (AP) system, etc. External system interface 904 may query a third-party system using an API or CLI. For example, external system interface 904 may query a firewall or a switch for information (e.g., network session information) about an entity or for a list of entities that are communicatively coupled to the firewall or switch and communications associated therewith. In some embodiments, external system interface 904 may query a switch, a firewall, or other system for information of communications associated with an entity.

Traffic monitor component 906 is operable to monitor network traffic to monitor network traffic for occurrences of network detectable events associated with attack patterns (e.g., generated by attack pattern generation component 920) of one or more cyber threats. Traffic monitor component 906 may have a packet engine operable to access packets of network traffic (e.g., passively) and analyze the network traffic. The traffic monitor component 906 may further be able to access and analyze traffic logs from one or more entities (e.g., network device 104, system 150, or aggregation device 106) or from an entity being monitored. The traffic monitor component 906 may further be able to access traffic analysis data associated with an entity being monitored, e.g., where the traffic analysis is performed by a third-party system.

Data access component 908 may be operable for accessing data including metadata associated with one or more network monitoring entities (e.g., network monitor entities 102), including features that the network monitoring entity is monitoring or collecting, software versions (e.g., of the profile library of the network monitoring entity), and the internal configuration of the network monitoring entity. The data accessed by data access component 908 may be used by embodiments to perform attack pattern matching (e.g., by attack pattern matching component 922). Data access component 908 may further access vertical or environment data and other user associated data, including vertical, environment, common type of entities for the network or network portions, segments, areas with classification issues, etc., which may be used for classification.

Data access component 908 may access data associated with active or passive traffic analysis or scans or a combination thereof. Information accessed by data access component 908 may be stored, displayed, and used as a basis for attack pattern matching via network detectable events, as described herein.

CTI matching component 910 is configured to retrieve tactical information from CTIs for one or more cyber threats. In some examples, the CTI matching component 910 may be the same or similar to CTI matching component 215 described with respect to FIG. 2. For example, the CTI matching component 910 may receive a hash or other identifiers or indicators of a cyber threat and then search for tactical information from CTI sources that match the hash, identifiers, or indicators of the cyber threat. The CTI matching component 910 then retrieves or otherwise extracts the tactical information from the CTI sources to be filtered and analyzed for attack pattern generation.

CTI filtering component 912 is configured to filter and rank the CTI reports to identify the most useful information to build attack patterns. The CTI filtering component 912 may filter the reports that contain only low-level information such as IoCs or other operation information (e.g., that do not include behavior or methodologies of a threat). The CTI filtering component 912 may then rank the remaining CTI reports based on quality of information with respect to attack execution plans and methods that can help identify an ongoing attack by observing the network (e.g., via network detectable events). For example, the CTI filtering component 912 may rank the CTI reports based on the number of network mappable TTPs that are included (e.g., TTPs that are related to a network detectable event). The CTI filtering component 912 may then filter out CTI reports that include less than a threshold number of network mappable TTPs. The CTI filtering component 912 may provide the remaining CTI reports to the attack pattern generation component 920 for generation of attack patterns for the cyber threat.

Display component 914 is configured to optionally display one or more graphical user interfaces or other interfaces (e.g., command line interface) for depicting various information associated with entities, entity classification, and exposed services at open ports of entities on the network, as described herein. In some embodiments, display component 914 may display or render a graphical or text based depiction of the automatically generated attack pattern. Display component 914 may further display information associated with an attack pattern that was matched by one or more events (e.g., network events) or other cyber threats.

Notification component 916 is operable to initiate one or more notifications based on the results of the generated attack patterns or attack pattern matching, as described herein. The notification may be any of a variety of notifications, e.g., IT ticket, email, SMS, a HTTP notification, conflict alerts, etc., as described herein.

Policy component 918 is operable for initiating or triggering one or more remediation actions or security actions according to one or more policies, e.g., based on an identification of an ongoing cyber-attack based on generated attack patterns, as described herein. For example, the policy component 918 may adjust access policies and access rules of the network and devices of the network to address and mitigate effects of the identified attack. Policy component 918 may further be configured to perform other operations including checking compliance status, finding open ports, etc. In some embodiments, policy component 918 may verify that an assignment of one or more access rules to one or more enforcement points has been properly assigned or configured. Policy component 918 may restrict network access, signal a patch system or service, signal an update system or service, etc., as described herein. The policy component 918 may thus, among other things, invoke automatically (e.g., without user or human interaction) patching, automatically updating, and automatically restrict network access of an entity (e.g., that has out-of-date software or based on access rule violation or attempted violation).

The actions may include restricting network access to a particular level (e.g., full, limited, or no network access, for instance via an enforcement point), remediation actions (e.g., triggering patch systems or services, triggering update systems or services, triggering third party product action, etc.), informational actions (e.g., sending an email notification to a user or IT administrator or creating an IT ticket reflecting the level of compliance), and logging actions (e.g., logging or storing the compliance level).

Attack pattern generation component 920 may be the same, or similar to, attack pattern generator 225, as described with respect to FIG. 2. Attack pattern generation component 920 is configured to map TTPs identified from the relevant CTI reports to one or more network detectable events. Accordingly, the attack pattern generation component 920 generates an attack pattern including set of network detectable events corresponding to the TTPs of the CTI. Additionally, the attack pattern generation component 920 may also provide a time window associated with the attack pattern and a threat level of the attack. The threat level may indicate an amount of harm that may be caused to the network or entity associated with the network that could be caused by the attack. In some embodiments, the attack pattern includes a particular sequence in which the network detectable events are to occur for the pattern to be matched.

Attack pattern matching component 922 may be the same, or similar to, attack pattern matching component 232, as described with respect to FIG. 2. The attack pattern matching component 922 is configured to identify and match events detected on the network (e.g., via traffic monitor component 906) to the network detectable events included in the attack pattern. The attack pattern matching component 922 may determine if a threshold number of the network detectable events have occurred within the defined window of time. Additionally, in some embodiments, the attack pattern matching component 922 determines whether the network detectable events have occurred in the particular sequence defined by the attack pattern. The alert generation component 924 is configured to generate an alert including an indication of the cyber threat in response to the attack pattern matching component 922 determining that the attack pattern has been triggered (e.g., threshold number of events of the attack pattern have occurred). The alert may include an identification of the attack, a certainty level of the indicated attack, a threat level of the attack, and recommended remediation actions. In some embodiments, processing logic (e.g., network monitor device 102) may automatically perform remediation actions to counteract the detected attack in response to the alert.

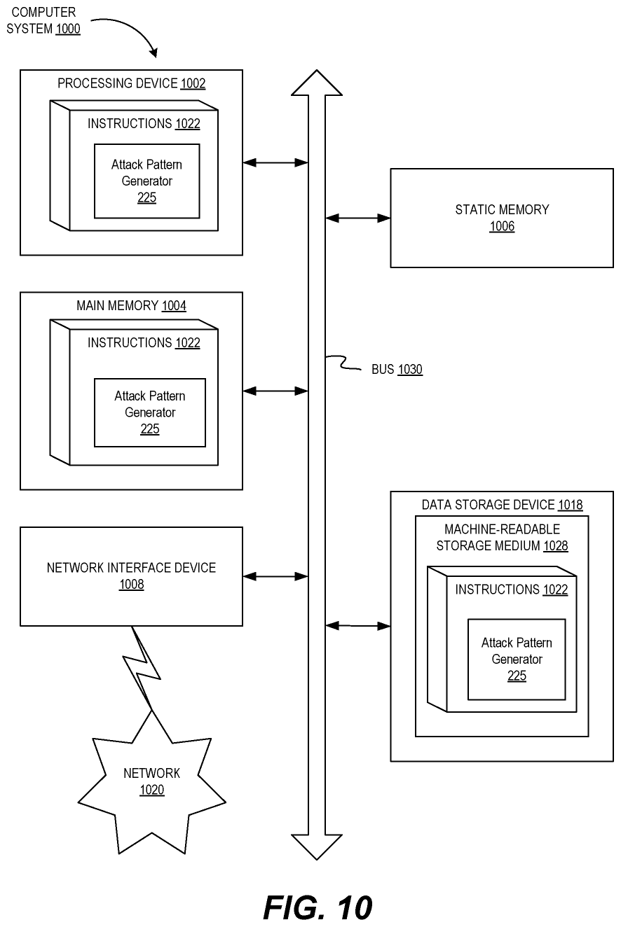

FIG. 10 illustrates a diagrammatic representation of a machine in the example form of a computer system 1000 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1000 may be representative of a server, such as network monitor entity 102 running system 900 to automatically generate and detect attack patterns from cyber threat intelligence.

The exemplary computer system 1000 includes a processing device 1002, a main memory 1004 (e.g., read-only memory (ROM), flash memory, dynamic random access memory (DRAM), a static memory 1006 (e.g., flash memory, static random access memory (SRAM), etc.), and a data storage device 1018, which communicate with each other via a bus 1030. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1002 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions 1022, which may be one example of system 900 shown in FIG. 10, for performing the operations and steps discussed herein.

The data storage device 1018 may include a machine-readable storage medium 1028, on which is stored one or more set of instructions 1022 (e.g., software) embodying any one or more of the methodologies of operations described herein, including instructions to cause the processing device 1002 to execute a cloud classification service. The instructions 1022 may also reside, completely or at least partially, within the main memory 1004 or within the processing device 1002 during execution thereof by the computer system 1000; the main memory 1004 and the processing device 1002 also constituting machine-readable storage media. The instructions 1022 may further be transmitted or received over a network 1020 via the network interface device 1008.

The machine-readable storage medium 1028 may also be used to store instructions to perform a method automatic attack pattern generation and detection from cyber threat intelligence, as described herein. While the machine-readable storage medium 1028 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
obtaining cyber threat intelligence comprising a plurality of methodologies used by a cyber threat;
identifying, by a processing device, a plurality of detectable events associated with the plurality of methodologies used by the cyber threat; and
generating an attack pattern for the cyber threat, wherein the attack pattern comprises the plurality of detectable events associated with the plurality of methodologies.

2. The method of claim 1, further comprising:
determining a subset of the plurality of methodologies that are detectable within a network; and
generating the attack pattern to comprise the detectable events associated with the subset of the plurality of methodologies.

3. The method of claim 1, further comprising:
detecting an occurrence of the plurality of detectable events of the attack pattern; and
in response to detecting the occurrence of the detectable events of the attack pattern, providing an indication of a potential network threat.

4. The method of claim 3, further comprising:
identifying the potential network threat as the cyber threat based on detecting the occurrence of the plurality of detectable events of the attack pattern.

5. The method of claim 1, wherein the attack pattern comprises a sequential order of the detectable events.

6. The method of claim 1, further comprising:
detecting an occurrence of a threshold number of the plurality of detectable events within a maximum period of time; and
providing an indication of a potential network threat.

7. The method of claim 1, wherein the methodologies comprise techniques, tactics, and procedures associated with the cyber threat.

8. A system comprising:
a memory; and
a processing device, operatively coupled to the memory, to:
obtain cyber threat intelligence comprising a plurality of methodologies used by a cyber threat;
identify a plurality of detectable events associated with the plurality of methodologies used by the cyber threat; and
generate an attack pattern for the cyber threat, wherein the attack pattern comprises the plurality of detectable events associated with the plurality of methodologies.

9. The system of claim 8, wherein the processing device is further to:
determine a subset of the plurality of methodologies that are detectable within a network; and
generate the attack pattern to comprise the detectable events associated with the subset of the plurality of methodologies.

10. The system of claim 8, wherein the processing device is further to:
detect an occurrence of the plurality of detectable events of the attack pattern; and
in response to detecting the occurrence of the detectable events of the attack pattern, provide an indication of a potential network threat.

11. The system of claim 10, wherein the processing device is further to:
identify the potential network threat as the cyber threat based on detecting the occurrence of the plurality of detectable events of the attack pattern.

12. The system of claim 8, wherein the attack pattern comprises a sequential order of the detectable events.

13. The system of claim 8, wherein the processing device is further to:
detect an occurrence of a threshold number of the plurality of detectable events within a maximum period of time; and
provide an indication of a potential network threat.

14. The system of claim 8, wherein the methodologies comprise techniques, tactics, and procedures associated with the cyber threat.

15. A non-transitory computer readable storage medium including instructions that, when executed by a processing device, cause the processing device to:
obtain cyber threat intelligence comprising a plurality of methodologies used by a cyber threat;
identify a plurality of detectable events associated with the plurality of methodologies used by the cyber threat; and
generate an attack pattern for the cyber threat, wherein the attack pattern comprises the plurality of detectable events associated with the plurality of methodologies.

16. The non-transitory computer readable medium of claim 15, wherein the processing device is further to:
determine a subset of the plurality of methodologies that are detectable within a network; and
generate the attack pattern to comprise the detectable events associated with the subset of the plurality of methodologies.

17. The non-transitory computer readable medium of claim 15, wherein the processing device is further to:
detect an occurrence of the plurality of detectable events of the attack pattern; and
in response to detecting the occurrence of the detectable events of the attack pattern, provide an indication of a potential network threat.

18. The non-transitory computer readable medium of claim 17, wherein the processing device is further to:
identify the potential network threat as the cyber threat based on detecting the occurrence of the plurality of detectable events of the attack pattern.

19. The non-transitory computer readable medium of claim 15, wherein the attack pattern comprises a sequential order of the detectable events.

20. The non-transitory computer readable medium of claim 15, wherein the processing device is further to:
detect an occurrence of a threshold number of the plurality of detectable events within a maximum period of time; and
provide an indication of a potential network threat.
